(19) United States
(12) Patent Application Publication
(10) Pub. No.: US 2014/0372610 A1
(43) Pub. Date: Dec. 18, 2014

(54) CORE NETWORK AND ACCESS POINT FOR FILTERING INFORMATION, AND INFORMATION FILTERING METHOD THEREOF

(71) Applicants: HON HAI PRECISION INDUSTRY CO., LTD., New Taipei (TW); Fu Tai Hua Industry (Shenzhen) Co., Ltd., Shenzhen (CN)

(72) Inventor: DAN CAO, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 14/054,806

(22) Filed: Oct. 15, 2013

(30) Foreign Application Priority Data
Jun. 18, 2013 (CN) 2013102410896

(51) Int. Cl. H04L 29/06

(52) U.S. Cl. CPC H04L 65/10
USPC 709/225

(57) ABSTRACT

An information filtering method is applied in a core network connected to a number of access networks. Each access network includes at least one access point for connecting user equipment to the core network. The method includes the following steps. Obtaining connecting configuration of one access point when the core network sends information to user equipment connected to the core network via the access point. Determining the access point belongs to which access network according to a first relationship between connecting configurations of each access point and the access network each access point belongs to. Determining which type the determined access network is. Determining the information needed to be filtered according to a second relationship between different types of the access networks and information needed to be filtered. Filtering the determined information to prevent the determined information from being accessed by the user equipment.

### BACKGROUND

1. Technical Field

The present disclosure relates to core networks and access points, and particularly, to a core network and an access point capable of filtering harmful information, and an information filtering method.

2. Description of Related Art

Information filtering technology is widely used in networks (e.g., on the Internet) to prevent some information from being accessed by user equipment. Generally, the information filtering technology determines which information needs to be filtered according to the type of information, that is, whether or not the information is advertising, pornography, violence, or reactionary information, and this filtering technology may bring some inconvenience to users. For example, advertising may be improper for students who usually use education networks, but may be useful for business men who usually use business networks. If the advertising is filtered from the business networks, then useful information for the businessman will be filtered as well. Therefore, there is a need to provide a means to overcome the above-described shortcomings.

### BRIEF DESCRIPTION OF THE DRAWINGS

Many aspects of the present disclosure should be better understood with reference to the following drawings. The emphasis is placed upon clearly illustrating the principles of the present disclosure.

FIG. 1 is a block diagram showing a core network connected to an access network, in accordance with an exemplary embodiment.

FIG. 2 is a block diagram showing a core network connected to an access network, in accordance with another exemplary embodiment.

FIG. 3 is a flowchart of an information filtering method, in accordance with an exemplary embodiment.

### DETAILED DESCRIPTION

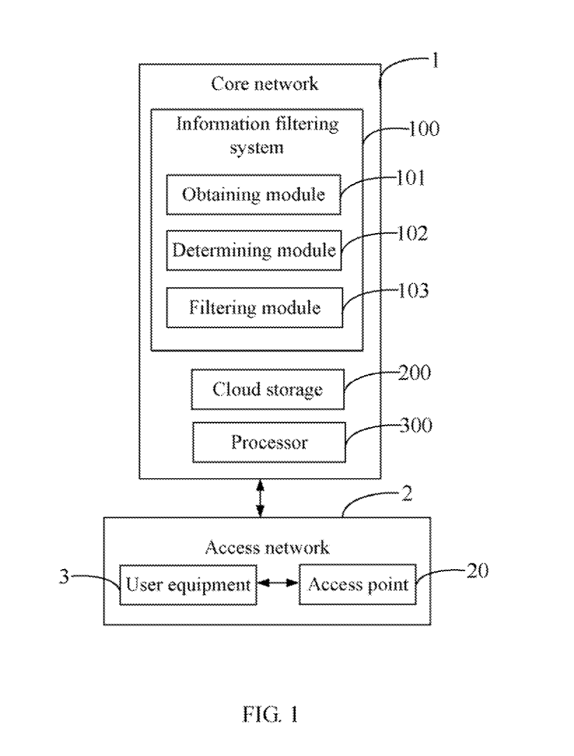

FIG. 1 illustrates an embodiment of a core network 1. The core network 100 is connected to a number of access networks 2. Each access network 2 includes at least one access point 20, such as a base station for example, for connecting user equipment 3 (e.g., mobile terminals or tablet computers) to the core network 1. The access networks 2 may include a community network, a business network, and an education network. The core network 1 further includes a cloud storage 200 and a processor 300. The cloud storage 200 stores an information filtering system 100. The system 100 includes a variety of modules which are collection of software instructions executed by the processor 300 to provide the functions of the system 100. The detail description of the system 100 will be provided below.

The system 100 includes an obtaining module 101, a determining module 102, and a filtering module 103.

The obtaining module 101 obtains connecting configuration of one access point 20 when the core network 1 determines to send information to user equipment 3 connected to the core network 1 via the access point 20. Specifically, the connecting configuration of the access point 20 includes the Service Set Identifier (SSID) of the access point 20 or the IP address that the access point 20 assigns to the user equipment 3. The information sent by the core network 1 can be advertisements, messages, images, and so on.

In the embodiment, the information from the core network 1 is sent to the user equipment 3 in response to an access request from the user equipment 3. In the illustrated embodiment, when the user equipment 3 sends an access request to the access point 20 via the access network 2, the core network 1 sends the information corresponding to the access request to the user equipment 3. That is, the obtaining module 101 obtains the connecting configuration of the access point 20 when the core network 1 responds to an access request from the user equipment 3 and sends the corresponding information to the user equipment 3. In an alternative embodiment, the information from the core network 1 is automatically sent to the user equipment 3 which is connected to the core network 1 via the access point 20. That is, the obtaining module 101 obtains the connecting configuration of the access point 20 each time the core network 1 automatically sends information to the user equipment 3.

The cloud storage 200 stores a first relationship between the connecting configurations of each access point 20 and the access network 2 each access point 20 belongs to. The cloud storage 200 further stores a second relationship between different types of the access networks 2 and information needed to be filtered. The determining module 102 determines which access network 20 the access point 20 belongs to according to the first relationship when the core network 1 determines to send information to the user equipment via the access point 20, determines which type the determined access network 20 is, and then determines the information needed to be filtered according to the second relationship.

The filtering module 103 filters the determined information to prevent the determined information from being accessed by the user equipment 3.

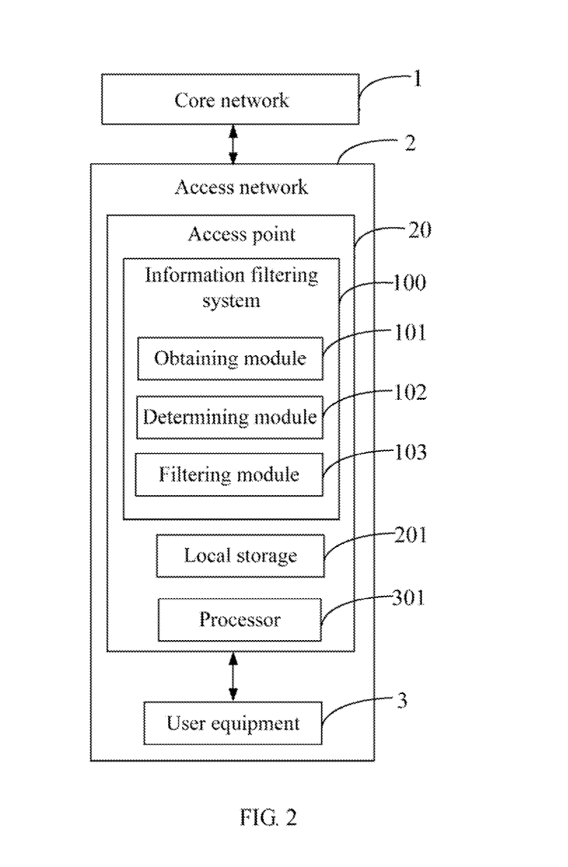

FIG. 2 shows in an alternative embodiment, each access point 20 includes a local storage 201 to store the system 100, and a processor 301 to execute different modules of the system 100 to perform the functions of the system 100. In this case, the local storage 201 stores the first relationship between the connecting configurations of the access point 20 and the access network 2 the access point 20 belongs to. The local storage 201 further stores the second relationship between different types of the access networks 2 and information needed to be filtered. Then, the determining module 102 determines which access network 20 the access point 20 belongs to according to the first relationship, determines which type the determined access network 20 is, and then determines the information needed to be filtered according to the second relationship.

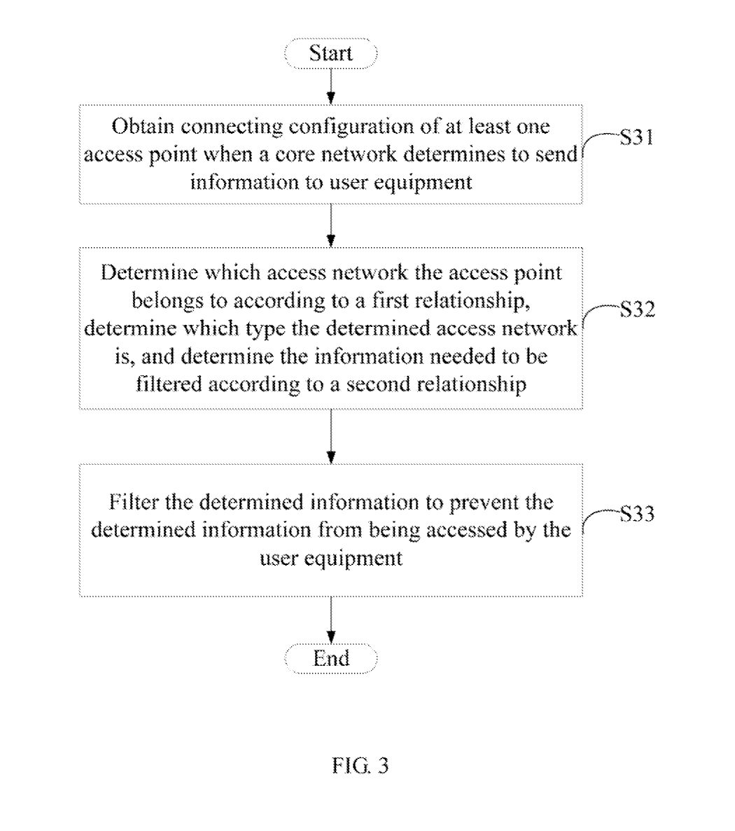

FIG. 3 is a flowchart of an information filtering method, in accordance with an exemplary embodiment.

In step S31, the obtaining module 101 obtains connecting configuration of one access point 20 when the core network 1 sends information to user equipment 3 connected to the core network 1 via the access point 20.

In step S32, the determining module 102 determines which access network 20 the access point 20 belongs to according to the first relationship when the core network 1 sends information to the user equipment via the access point 20, determines which type the determined access network 20 is, and then determines the information needed to be filtered according to the second relationship.

In step S33, the filtering module 103 filters the determined information to prevent the determined information from being accessed by the user equipment 3.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments.

What is claimed is:

1. A core network connected to a plurality of access networks, each access network comprising at least one access point for connecting user equipment to the core network, the core network comprising:
a cloud storage storing a plurality of modules, a first relationship between connecting configurations of each access point and the access network each access point belongs to, and a second relationship between different types of the access networks and information needed to be filtered; and
a processor to execute the plurality of modules, wherein the plurality of modules comprises:
an obtaining module to obtain connecting configuration of one of the at least one access point when the core network determines to send information to user equipment connected to the core network via the access point;
a determining module to determine which access network the one access point belongs to according to the first relationship, determine which type the determined access network is, and determine the information needed to be filtered according to the second relationship; and
a filtering module to filter the determined information to prevent the determined information from being accessed by the user equipment.

2. The core network of claim 1, wherein the connecting configuration of the access point comprises a Service Set Identifier of the access point.

3. The core network of claim 1, wherein the connecting configuration of the access point comprises an IP address the access point assigns to the user equipment.

4. The core network of claim 1, wherein the obtaining module is configured to obtain the connecting configuration of the access point when the core network responds to an access request from the user equipment and sends the corresponding information to the user equipment.

5. The core network of claim 1, wherein the obtaining module is configured to obtain the connecting configuration of the access point each time the core network automatically sends information to the user equipment.

6. An access point comprised in an access network, a plurality of the access networks being connected to a core network, the access point being configured for connecting user equipments to the core network, the access point comprising:
a local storage storing a plurality of modules, a first relationship between connecting configurations of the access point and the access network the access point belongs to, and a second relationship between different types of the access networks and information needed to be filtered; and
a processor to execute the plurality of modules, wherein the plurality of modules comprises:
an obtaining module to obtain connecting configuration of one access point when the core network determines to send information to user equipment connected to the core network via the access point;
a determining module to determine which access network the access point belongs to according to the first relationship, determine which type the determined access network is, and determine the information needed to be filtered according to the second relationship; and
a filtering module to filter the determined information to prevent the determined information from being accessed by the user equipment.

7. The access point of claim 6, wherein the connecting configuration of the access point comprises a Service Set Identifier of the access point.

8. The access point of claim 6, wherein the connecting configuration of the access point comprises an IP address the access point assigns to the user equipment.

9. An information filtering method applied in a core network, the core network connected to a plurality of access networks, each access network comprising at least one access point for connecting user equipments to the core network, the core network comprising a cloud storage for storing a first relationship between connecting configurations of each access point and the access network each access point belongs to, and a second relationship between different types of the access networks and information needed to be filtered, the method comprising:
obtaining connecting configuration of one of the at least one access point when the core network determines to send information to user equipment connected to the core network via the access point;
determining the access point belongs to which access network according to the first relationship;
determining which type the determined access network is;
determining the information needed to be filtered according to the second relationship; and
filtering the determined information to prevent the determined information from being accessed by the user equipment.
